(19) United States
(12) Patent Application Publication
(10) Pub. No.: US 2009/0082480 A1
(43) Pub. Date: Mar. 26, 2009

(54) POLYMERIC BINDING MATERIALS

(75) Inventors: Sergey Anatoliyovich Piletsky, Cranfield (GB); Olena Volodimirivna Piletska, Cranfield (GB); Anthony Peter Francis Turner, Wilstead (GB); Igor Dubey, Kyiv (UA); Larysa Dubey, Kyiv (UA)

Correspondence Address: STITES & HARBISON PLLC, 1199 NORTH FAIRFAX STREET, SUITE 900, ALEXANDRIA, VA, 22314, US

(73) Assignee: CRANFIELD UNIVERSITY, Bedfordshire (GB)

(21) Appl. No.: 11/916,948

(22) PCT Filed: Jun. 6, 2006
(86) PCT No.: PCT/GB2006/002073

§ 371 Date: Oct. 14, 2008

(30) Foreign Application Priority Data
Jun. 8, 2005 (GB) 0511641.3

(51) Int. Cl. C08L 33/08; C08F 8/12

(52) U.S. Cl. 521/147; 525/384

(57) ABSTRACT

A monomer having a pair of hydroxy groups held in a fixed relationship (e.g. a dihydroxybenzene) is diesterified with a compound having a polymerisable group, e.g. to form a diacrylate. After polymerisation with a crosslinker, the polymer is hydrolysed. The dihydroxy-monomer is removed, leaving a polymer with pair of carboxyl groups held in spatial relationships determined by the dihydroxy monomer. Thus a range of subtly different polymers can be prepared by using different dihydroxy-monomer templates. The polymers are desirably swellable. They can be used as selective binding materials, e.g. in chromatography or analysis.

### TECHNICAL FIELD

The present invention relates to polymeric binding materials, their preparation and use. Preferred embodiments involve materials with enhanced affinity and specificity for drugs.

### BACKGROUND ART

| Patent | Issued | Title |
|---|---|---|
| 4,127,730 | Nov. 28, 1978 | Method of preparing polymers |
| USA | | analogous to enzymes |
| 5,110,833 | May 5, 1992 | Preparation of synthetic enzymes |
| USA | | and synthetic antibodies and use |
| | | of the thus prepared enzymes and |
| | | antibodies |
| 5,756,717 | May 26, 1998 | Protein imaging |
| USA | | |
| 5,641,539 | Jun. 24, 1997 | Molecular imaging |
| USA | | |

1. Mukawa T., Goto T., Nariai H., Aoki Y., Imamura A., Takeuchi T. (2003). Novel strategy for molecular imprinting of phenolic compounds utilizing disulfide templates. J. Pharm. Biomed. Anal., 30, 1943-1947.
2. Joshi V. P., Karode S. K., Kulkarni M. G., Mashelkar R. A. (1998). Novel strategies based on molecularly imprinted adsorbents. Chem. Engin. Sci., 53, 2271-2284.
3. Lee K., Ki C. D., Chang J. Y. (2004). Selectivity control by chemical modification of the recognition sites in two-point binding molecularly imprinted polymer. Macromol., 37, 6644-5549.
4. Wulff G., Schulze I. (1978). Enzyme-analogue built polymers. IX. Polymers with mercapto groups of definite cooperativity. Isr. J. Chem. 17, 291-297.
5. Wulff Heide G. B., Helfmeier G. (1986). Molecular recognition through the exact placement of functional groups on rigid matrices via a template approach. J. Am. Chem. Soc., 108, 1089-1091.
6. Wulff G., Heide B., Helfmeier G. (1987). Enzyme-analogue built polymers, 24) On the distance accuracy of functional groups in polymers and silicas introduced by a template approach. React. Polym., 6, 299-310.

During the last decades, the molecular imprinting approach has been used in a variety of forms and applications [see referred patents and references 1-3]. In this technique a highly cross-linked polymer is formed around a template molecule. The template is then removed by washing and a cavity with functional groups complementary to these of template molecule remains behind in a polymer. Usually the synthesised polymers possess a high level of cross-linking to ensure fidelity of binding sites for the target template. These polymers demonstrate very good thermal and mechanical stability and can be used in aggressive media. The disadvantage of this approach for some industrial applications lies in the high degree of selectivity of synthesised materials, which in most cases bind predominantly template molecules used in polymer preparation. The modern separation technology would prefer having generic adsorbents which can recognise not the individual molecules, but rather groups of compounds with similar structure. In theory it would be possible to separate all molecules into different groups which have common (similar) orientation of 2-3 polar functional groups (determinants). Ideally 20-30 adsorbents capable of recognising these determinants should be sufficient to solve most of separation tasks existing in analytical science and in industry. The present invention is focused on the development of polymeric adsorbents with two carboxylic groups, fixed inside of binding cavity at a varying distance. These materials are capable e.g. of selective binding to drug molecules having two vicinal polar moieties such as e.g. amino or imino groups.

### DISCLOSURE OF THE INVENTION

The present invention provides a method of producing a polymeric binding material comprising:

(a) providing a first compound having in its molecule a framework bearing two hydroxy groups;

(b) providing a second compound having in its molecule (i) a group capable of forming an ester linkage with a hydroxy group of another molecule; and (ii) a polymerisable moiety;

(c) reacting the first and second compounds so that the two hydroxy groups of the first compound are esterified, producing a third compound in which said framework of the first compound is connected via respective ester linkages to two of said polymerisable moieties;

(d) copolymerising the third compound with a cross-linker capable of reaction with the polymerisable moieties to produce polymer linkages, the copolymerisation producing a first polymer containing third compound units linked together via said polymer linkages and residues of the cross-linker; and

(e) treating the first polymer under conditions effecting hydrolysis of the ester linkages to produce a second polymer containing pairs of carboxyl groups resulting from said hydrolysis.

In general, the present invention describes synthesis of (preferably swellable) affinity polymeric adsorbents and their application for the separation and purification of compounds, e.g. drugs. A preferred method for synthesis of such polymers comprises steps of: (i) co-polymerisation of polymerisable esters of 1,2-dihydroxybenzene, 1, 3-dihydroxybenzene, 1,4-dihydroxybenzene or their derivatives with appropriate cross-linkers using radical polymerisation; (ii) hydrolysis of ester linkages and release of corresponding dihydroxy derivatives; (iii) washing of the polymer from residues of dihydroxy derivative, monomers and initiator. Analogously affinity polymers can be synthesised using polymerisable esters of dihydroxy derivatives of cycloalkane, cycloalkene, cycloalkynes, heterocycle or macrocycles. Desirably the dihydroxy compounds have frameworks holding the hydroxy groups a fixed distance apart, so that the adsorbant polymer likewise has pairs of carboxyl groups (or derivatives thereof) with a corresponding spacing. The resulting materials desirably contain cavities. The material is desirably swellable. Thus the cavities are of adjustable size. The orientation of two carboxyl groups (or derivatives) is suited to the binding of a target such as the drug with appropriate size and complementary orientation of polar moieties. In contrast to the philosophy of “conventional” imprinting the synthesised materials would not require selectivity for the template (the dihydroxy compound), but rather for a group of compounds with suitable orientation of polar functionalities, such as e.g. adjacent vicinal amino or imino groups. The restriction is also eased on the rigidity of polymer which should have sufficient swelling ability to accommodate different drug derivatives or other targets.

### BRIEF DESCRIPTION OF THE DRAWINGS

FIG. 1 shows synthesis of diacrylate monomers by reacting corresponding phenol with acryloyl chloride

FIG. 2 shows the preparation of polymers using the diacrylate monomers.

### MODES FOR CARRYING OUT THE INVENTION

A first aspect of the present invention is the synthesis of polymeric affinity adsorbents. The preferred method for synthesis of such polymers comprises steps of: (i) co-polymerisation of polymerisable esters selected from 1,2-dihydroxybenzene, 1,3-dihydroxybenzene, 1,4-dihydroxybenzene and their derivatives with an appropriate cross-linker using radical polymerisation; (ii) hydrolysis of the ester linkages and release of corresponding dihydroxy derivative; (iii) washing of the polymer from residues of dihydroxy derivative, monomers and initiator. The polymerisable esters could contain residues of acrylic, methacrylic or trifluoromethacrylic acid which can be cleaved from the ester by alkaline hydrolysis. Different dihydroxy derivatives direct positioning of carboxyl-group-containing monomers in the resulting polymer, providing selective binding sites with varying distance between carboxyl groups. The role of cross-linker lies in the formation of a three-dimensional network capable of preserving orientation and distance between two carboxyl groups. The level of cross-linking should not be excessive in order to accommodate different drug derivatives or other target species.

The present invention is not aimed at the development of traditional MIPs which have affinity specifically for the corresponding templates. In reality the polymers prepared as described in the present invention most likely will have most affinity not to the template but to different, possibly non-related compounds with proper orientation of functional groups.

The polymerisation is generally performed in the presence of solvent which helps to solubilise components and to create pores in the polymer matrix, suitable for an effective transport of solution, required for chromatographic application of these materials. The polymerisation mixture normally contains initiator which generates free radicals in radical polymerisation.

For some applications, instead of dihydroxybenzene derivatives, dihydroxy derivatives of other generally cyclic compounds may be used, e.g. cycloalkanes, cycloalkenes, cylcoalkynes, heterocycles or macrocycles. The use of these substances might be necessary for some applications where the separation task will require adsorbents with different properties, e.g. larger cavities and/or larger distances between the two carboxyl groups of a pair. The cross-linker used for the polymer preparation is preferably selected from vinyl, allyl or styrene derivatives, with non-exclusive examples of divinylbenzene, divinylnaphthalene, divinyl ether and their mixtures. The monomers are generally present in the polymerisation mixture in an amount of from about 10 to 80 vol. %, and more preferably in an amount of from about 40 to 80 vol. %. Solvent may be selected from a group including aliphatic hydrocarbons, aromatic hydrocarbons, esters, alcohols, ketones, ethers, butyl alcohols, isobutyl alcohol, dimethyl sulfide, formamide, cyclohexanol, H₂O, glycerol, sodium acetate, solutions of soluble polymers, and mixtures thereof. A pore-forming component is desirably present in the monomer mixture in an amount of from 5 to 60 vol %. Conventional free-radical-generating polymerisation initiators may be employed to initiate polymerisation. Examples of suitable initiators include peroxides such as OO-t-amyl-O-(2ethylhexyl)monoperoxycarbonate, dipropylperoxydicarbonate, and benzoyl peroxide, as well as azo compounds such as azobisisobutyronitrile, 2,2′-azobis(2-amidinopropane)dihydrochloride, 2,2′-azobis(isobutyramide)dihydrate and 1,1′-azobis (cyclohexane carbonitrile). The initiator is generally present in the polymerisation mixture in an amount of from about 0.2 to 5% by weight of the monomers. The polymerisation can be initiated by UV irradiation or thermally. The polymerisation could be performed by different methods known to experienced artisans, such as bulk polymerisation, polymerisation in suspension and emulsion, precipitation polymerisation, and living polymerisation.

In the production method of the present invention, the initial polymer is subjected to hydrolysis to release the dihydroxy derivative. This may be achieved by acidic or basic hydrolysis, preferably by treatment with sodium, ammonium or potassium hydroxide.

FIG. 2 schematically shows the starting monomers (diacrylates of o, m and p-dihydroxybenzene), and the final polymers. The dihydroxybenzene components have been removed from the polymers (by hydrolysis), but the acrylate moieties keep their relative positions. Thus the spacings of the pairs of carboxyl groups are characteristically different, giving the polymers different binding properties.

The resulting hydrolysed polymer is generally washed to remove non-polymeric material, such as residues of the monomers, initiator etc. The preferable way to remove unbound material is by washing with organic solvent, such as methanol, acetonitrile, acetone, and/or with water. Additional treatment steps might include one or more of grinding, filtration, sonification, electrophoresis, chromatographic separation, washing, and centrifugation.

The present invention may employ postpolymerisation modification of the binding sites (carboxyl groups) by chemical treatment. Thus carboxyl groups can be oxidised with periodate to produce aldehyde groups. Aldehyde groups can be transformed into Schiff bases by reaction with a primary amine. Sodium borohydride can be used to convert the aldehyde groups into primary alcohols, and Schiff bases into secondary amines. The skilled artisan with knowledge of organic chemistry would be able to use synthetic methods to modify binding sites to create different functionalities in the polymer suited for the recognition of different drug molecules.

Another aspect of the present invention is the application of synthesised materials. The preferred area of application involves drug separation. It would be possible to use the materials in chromatography, electrophoresis, sensing and in solid phase extraction in accordance with conventional techniques known in the art.

### EXAMPLES

The Examples are intended to illustrate, but not limit the scope of the invention.

### Example 1

### Preparation of Polymers

### a) Synthesis of Diacrylate Monomers

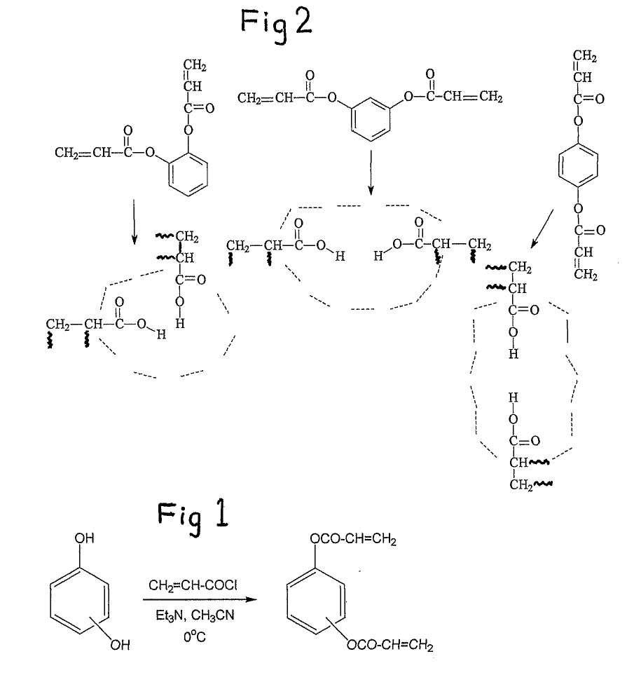

The monomer synthesis employs an acylation reaction as shown in FIG. 1. 4.4 g of a dihydric phenol (catechol, resorcinol or hydroquinone), (40 mmol) and 14 ml of triethylamine (100 mmol) in 75 ml of dry acetonitrile were cooled in an ice bath. A solution of acryloyl chloride (8 ml, 100 mmol) in 25 ml CH₃CN was added dropwise with stirring over 30 min. The stirring was continued for another 2 hours with cooling. Precipitated triethylamine hydrochloride was filtered off, and washed with solvent (acetonitrile, 2×20 ml). The washings were combined with the reaction solution, and the solvent was removed under reduced pressure. 200 ml of chloroform was added to the residue. The resulting solution was washed with saturated aqueous NaHCO₃ (2×100 ml), dried with anhydrous sodium sulfate, filtered and evaporated. The mixture was separated on silica gel using chloroform as an eluent. The product was then re-purified on a silica column in 20% hexane in chloroform. Corresponding fractions were evaporated and dried in vacuum to constant mass. Catechol diacrylate: yield 5.7 g (66%), colourless liquid that solidified upon storage at 4° C. forming crystalline mass. Resorcinol diacrylate: yield 5.6 g (64%), colourless liquid. Hydroquinone diacrylate: yield 5.3 g (61%), white solid. The structures of monomers were confirmed by electrospray mass-spectroscopy (ESI MS).

### b) Preparation of Polymers

The total process for the preparation of affinity polymers with fixed distance between the functional groups is presented schematically in FIG. 2. 300 mg of diacrylate monomer, 2.7 g of cross-linker (divinylbenzene) and 30 mg of initiator 1,1′-azobis(cyclohexanecarbonitrile) were dissolved in 3 g of dimethylformamide. The reaction mixtures were de-aerated by passing nitrogen gas for 2 min, then the tubes were tightly sealed and kept in a thermostatic oil bath at 80° C. overnight (18 h). Corresponding blank polymers were prepared in the absence of the template phenol derivatives, i.e. 3 g of cross-linker was used for the polymerization. Polymers containing methacrylic, acrylic and itaconic acid were prepared as controls. The bulk polymers were manually ground in methanol and mechanically wet-sieved through 106 and 45 μm sieves (Endecotts, UK). Polymer particles with a size range of 38-106 μm were collected and dried.

### Example 2

### Hydrolysis of the Polymers

Phenolic residues were cleaved from the polymers by the treatment with 0.75 M NaOH in water-ethanol 3:1 for 10 h at 60° C. with occasional agitation. During this period, alkaline solution was changed several times (polymer was filtered off, washed with 0.75 M NaOH and the fresh portion of NaOH solution was added). Hydrolyzed polymers were filtered off, washed with 50% aqueous ethanol (5×20 ml) and water (5×20 ml). Blank polymers were washed with 0.5 M NaOH in 50% ethanol-water (5×20 ml) and water (10×20 ml). Then all polymers were washed with diluted HC1, by slowly passing 150 ml of 0.5% acid solution through the polymers for 30 min to recover the free carboxylic groups. Then polymers were thoroughly washed with distilled water until pH of eluant was neutral, and methanol (3×20 ml). Fine particles were removed by washing polymers with methanol on 45 μm sieve. Polymers were stored in methanol. Methanolic suspensions were used for packing HPLC columns.

### Example 3

### Computational Analysis of the Binding Sites

Molecular modelling has been performed on a workstation Silicon Graphics Octane running IRIX 6.5 operating system. The workstation was configured with two 195 MHz reduced instruction set processors, 712 MB memory and a 12 GB fixed drive. This system was used to execute the software package SYBYL 6.7 (Tripos Inc., USA). Analysis of the distances between functional groups in corresponding molecular models has been performed using FlexiDock algorithm which is an essential component of the SYBYL® Molecular Modelling Environment, and is provided as a part of its Biopolymer module.

At the beginning of the experiment molecular models of three heterocycles and acrylic acid were created. In addition the molecular models of the diacrylate monomers synthesised as described in Example 1a). Next the SYBYL's™ docking function was used to position two molecules of acrylic acid in the most energetically favourable orientation around heterocycle. The distance between carboxylic functionalities was calculated and compared with the distance between the carboxyls in diacrylate monomers (see Table 1). In accordance with these results the best polymer for the recognition of pyridazine should be the one prepared using catechol derivative. Pyrazine should have the strongest binding to the polymer prepared using hydroquinone. In the case of pyrimidine the prognosis is difficult to make since all three polymers should be capable of binding this heterocycle.

TABLE 1
Calculated distance between carboxylic groups in
the binding site and in the complexes between acrylic
acid and hetercocycles (as shown in FIG. 2).

| | | Optimal distance between |
|---|---|---|
| | Calculated distance | carboxylic groups in |
| | between carboxylic | complexes of acrylic |
| Derivative | acids in binding site | acid with heterocycle |
| Ortho | 2.8 Å | 1.6-3.0 Å |
| Metha | 4.8 Å | 3.1-5.3 Å |
| Para | 5.5 Å | 5.8-8.0 Å |

### Example 4

### HPLC Analysis

HPLC was performed on a system consisting of ConstaMetric 3200 solvent delivery system (LDC Analytical, UK), Waters 717 plus autosampler and Lambda-Max 481 LC spectrophotometric detector (Waters, UK). HPLC column (4.6×100 mm) was packed with polymer (1 g, particle size 45-106 μm) in methanol. For HPLC analysis, 1 mg/ml sample solutions in CHCl₃+20% hexane were prepared, 20 μl was used for injection. HPLC was run at a flow rate 1 ml/min (isocratic elution, 10 min) with detection at 254 nm. Eluent composition was optimised for each polymer and set of compounds to be analysed. Reported chromatographic data represent the results of at least two concordant experiments. The standard deviation in the experiments was below 5%. Capacity factors k′ were determined from the equation k′=(t−t₀)/t₀, where t is the retention time of the given species and t₀ is the retention time of the void standard (acetone).

The results of testing are presented in Table 2. These results clearly indicate that the nature of the template has affected the affinity profile of synthesised polymers, e.g. pyridazine has the highest affinity to the polymer prepared using catechol derivative. Pyrazine has the strongest binding to the polymer prepared using hydroquinone. These results are in agreement with modeling data.

TABLE 2
The retention time of the heterocycles on the columns packed with
polymers prepared using diacrylate monomers, itaconic acid and acrylic
acid. The separation was performed in CHCl₃ containing 20% hexane.

| | k′ | | |
|---|---|---|---|
| | Pyridazine | Pyrimidine | Pyrazine |
| Polymer | (-ortho) | (-meta) | (-para) |
| P-ortho | 3.47 | 1.46 | 0.84 |
| P-meta | 1.75 | 1.67 | 0.77 |
| P-para | 2.03 | 2.37 | 1.66 |
| P-Itaconic | 1.81 | 1.96 | 1.36 |
| acid | | | |
| P-Acrylic | 0.89 | 1.15 | 0.86 |
| acid | | | |

Note
(a) P-ortho, P-meta and P-para mean the polymers prepared from ortho, meta, and para-dihydroxybenzene, respectively
P-Itaconic acid and P-acrylic acid mean polymers prepared using itaconic acid and acrylic acid, respectively.

### Example 5

### Swelling Analysis

Swelling experiments were performed as follows: 300 mg of the polymer particles with the mesh size 38-67 μm were packed in 1 ml solid-phase extraction cartridges (Supelco, UK). Cartridges were filled with 1 ml of chloroform. After 6 hours equilibration at 20° C. the excess of solvent was removed from the polymer by applying reduced pressure for 1 minute and the weight of the swollen polymer was measured. The swelling ratio (Sr) of the polymers was calculated from the following equation:

Sr=(mₛ−mₒ)/mₒ

Where mₛ is the mass of the swollen polymer and mₒ is the mass of dry polymer.

The swelling ratio of the polymers (after hydrolysis) are:

Catechol based polymer: 1.2
Resorcinol based polymer: 1.19
Hydroquinone based polymer: 1.15

Thus polymers prepared as described above swell on average 15-20%.

1. A method of producing a polymeric binding material comprising:
(a) providing a first compound having in its molecule a framework bearing two hydroxy groups;
(b) providing a second compound having in its molecule (i) a group capable of forming an ester linkage with a hydroxy group of another molecule; and (ii) a polymerisable moiety;
(c) reacting the first and second compounds so that the two hydroxy groups of the first compound are esterified, producing a third compound in which said framework of the first compound is connected via respective ester linkages to two of said polymerisable moieties;
(d) copolymerising the third compound with a cross-linker capable of reaction with the polymerisable moieties to produce polymer linkages, the copolymerisation producing a first polymer containing third compound units linked together via said polymer linkages and residues of the cross-linker; and
(e) treating the first polymer under conditions effecting hydrolysis of the ester linkages to produce a second polymer containing pairs of carboxyl groups resulting from said hydrolysis.

2. A method according to claim 1 wherein said first compound has a framework such that said two hydroxy groups have a predetermined spacing.

3. A method according to claim 1 wherein said first compound has a cyclic framework, the hydroxy groups being attached to ring atoms.

4. A method according to claim 3 wherein said cyclic framework is aromatic.

5. A method according to claim 4 wherein said first compound is a di hydroxybenzene.

6. A method according to a claim 1 wherein said polymerisable moiety is polymerisable using radical polymerisation, and step (d) employs radical polymerisation.

7. A method according to claim 1 wherein said polymerisable moiety is a moiety having ethylenic unsaturation.

8. A method according to claim 7 wherein said cross-linker is a vinyl, allyl or styryl compound.

9. A method according to claim 1 wherein the copolymerisation step (d) is carried out in the presence of a pore-forming compound.

10. A method according to claim 1 wherein after the hydrolysis step (e), the second polymer is washed to remove unbound material.

11. A method according to claim 1 including a further step of derivatisation in which the carboxyl groups of the second polymer are converted into different groups.

12. A method according to claim 1 in which the final polymer is swellable.

13. A method according to claim 1 including a step of using the product as a separation medium.

14. A method according to claim 12 wherein said second polymer contains cavities, said method including a further step (f) of effecting swelling of said second polymer, thereby altering the size of said cavities.

15. A method according to claim 14 wherein said second polymer has a swelling ratio in the range of 15-20%.

16. A method of separation comprising a step of contacting a sample solution with a separation medium which is a second polymer prepared by the method of claim 14.
